(19) United States
(12) Patent Application Publication
(10) Pub. No.: US 2024/0175282 A1
(43) Pub. Date: May 30, 2024

(54) TILT TOWER WITH BEARING ROTATABLY COUPLING SWING ARM TO MAST

(71) Applicant: Zero Climb Tower Company, LLC, Lindenhurst, IL (US)

(72) Inventors: Eamonn Connolly, Chicago, IL (US); John McDade, Lindenhurst, IL (US); Vinh Diep, Chicago, IL (US)

(21) Appl. No.: 18/521,599

(22) Filed: Nov. 28, 2023

Related U.S. Application Data
(60) Provisional application No. 63/385,259, filed on Nov. 29, 2022.

(51) Int. Cl. E04H 12/18; F16C 19/36

(52) U.S. Cl. CPC E04H 12/18; F16C 19/36

(57) ABSTRACT

A tilt tower, including a mast fixed to ground and a swing arm including a tube with a hollow interior portion. The tilt tower further includes a bearing rotatably coupling the swing arm to a side of an upper end of the mast. The bearing including a bearing seat coupled to the side of the upper end of the mast; an axle coupled to an exterior surface of the respective swing arm, the axle including a hollow interior portion connected to the interior of the tube of the swing arm; and a sealed roller bearing between the axle and the bearing seat.

### TECHNICAL FIELD

The disclosure generally relates to utility towers and, more particularly, to a tilt tower.

### BACKGROUND

Tilt towers are used to mount utility equipment such as radios, cellular transceivers, and antennas at an elevated height above the ground. Tilt towers include a mast and a swing arm pivotally coupled to the mast. The mast is fixed to the ground. The utility equipment is mounted to the upper end of the swing arm. The swing arm pivots near a midpoint thereof to allow the utility equipment to be lowered for access by a user on the ground. The tilt tower thus removes the need for a user to climb the tower or the need for boom trucks or cranes to access the utility equipment.

Tilt towers suffer from a number of deficiencies, however. Pivot assemblies, for example, are used near an upper end of the mast or near a middle of the swing arm to pivotally couple the swing arm to the mast. Current pivot assemblies use a surface mounted axle welded to the face of the swing arm with stiffeners, and a mating bearing surface on the mast. The bearing interface is greased but otherwise exposed to the environment. When grease leaks or is depleted through use or weather exposure, the frictional forces make operation of the swing arm difficult. However, ensuring proper lubrication of the pivot assembly is difficult due to its high placement on the mast. The pivot assembly is also the only structure supporting the swing arm, resulting in high stress, high friction, and potential fatigue issues in the swing arm, axle, stiffeners, and welds. The stress, friction, and fatigue issues are especially problematic as tilt towers are scaled for larger and taller applications, such as cell towers.

Real estate for utility towers is also expensive and difficult to develop due to various circumstances, such as siting, regulatory compliance, and capital expenses. Once a tower is erected, the owner may want to add equipment or additional entities may be interested in locating their utility equipment on the tower (referred to as “co-locating”). Conventional tilt towers provide a single swing arm. Additional utility equipment can be mounted lower on the swing arm once the main, upper frame is full, but once the capacity of the single swing arm is exhausted, it is impossible to add new utility equipment.

When installed, the swing arms are designed to have rotational balance to make them easy and safe to rotate. Counterweights are coupled to the lower end of the swing arm to ensure rotational balance when a tilt tower is installed, but the weights are fixed to the swing arm and not readily adjustable. Whenever new utility equipment (e.g., antennas, radios, etc.), related accessories (e.g., mounts, feedlines, connectors, etc.) or environmental conditions (e.g., snow, ice, or bird's nests) add weight to the swing arm, the rotational balance of the swing arm changes. Lanyards are used to control the swing of the swing arm, but when these weight-change situations occur, rotating the swing arm can be difficult and potentially dangerous, especially when the swing arm's rotation accelerates faster than expected.

### BRIEF DESCRIPTION

All aspects, examples and features mentioned below can be combined in any technically possible way.

An aspect of the disclosure provides a tilt tower, comprising: a mast fixed to ground; a swing arm including a tube with a hollow interior portion; and a bearing rotatably coupling the swing arm to a side of an upper end of the mast, the bearing including: a bearing seat coupled to the side of the upper end of the mast, an axle coupled to an exterior surface of the respective swing arm, wherein the axle includes a hollow interior portion connected to the interior of the tube of the swing arm, and a sealed roller bearing between the axle and the mast.

Another aspect of the disclosure includes any of the preceding aspects, and a hollow interior of the axle open to the hollow interior portion of the tube of the swing arm through an opening in a side of the swing arm.

Another aspect of the disclosure includes any of the preceding aspects, and the axle is cylindrical and includes a uniform circumference throughout the length of the axle.

Another aspect of the disclosure includes any of the preceding aspects, and a sealed roller bearing at least partially within a bearing seat of the bearing.

Another aspect of the disclosure includes any of the preceding aspects, and the axle includes a flange extending radially from a surface of the axle and is connected to the mast, and the bearing seat is at least partially about the flange.

Another aspect of the disclosure includes any of the preceding aspects, and a flange is operatively coupled to a backing plate between the flange and the mast.

Another aspect of the disclosure includes any of the preceding aspects, and the bearing seat of the bearing includes a first portion including a first hemispherical bearing surface and a second portion including a second hemispherical bearing surface, where the first portion and the second portion collectively form a respective circular bearing surface about the axle.

Another aspect of this disclosure provide a tilt tower, including a mast fixed to ground; a swing arm; and a bearing rotatably coupling the swing arm to a side of an upper end of the mast, the bearing including: a bearing seat coupled to the side of the upper end of the mast, the bearing seat including first portion including a first hemispherical bearing surface and a second portion including a second hemispherical bearing surface, where the first portion and the second portion collectively form a circular bearing surface, an axle coupled to an exterior surface of the swing arm, and a sealed roller bearing between the axle and the mast.

Another aspect of the disclosure includes any of the preceding aspects, and the bearing seat is physically connected to the side of the upper end of the mast by at least two fasteners, and where the bearing seat is selectively removable from the side of the upper end of the mast.

Another aspect of the disclosure includes any of the preceding aspects, and the first hemispherical bearing surface and second hemispherical bearing surface collectively form the circular bearing surface about the sealed roller bearing.

Another aspect of the disclosure includes any of the preceding aspects, and the sealed roller bearing is a spherical sealed roller bearing.

Another aspect of the disclosure includes any of the preceding aspects, and the sealed roller bearing is at least partially within a bearing seat of the bearing.

Another aspect of the disclosure includes any of the preceding aspects, and the bearing seat is permanently fixed to the mast.

Another aspect of the disclosure includes any of the preceding aspects, and the second portion of the bearing seat is selectively removable from the mast.

Another aspect of the disclosure includes any of the preceding aspects, and the axle includes a flange extending radially from a surface of the axle and is connected to the mast, the first portion and the portion each between the axle and the mast.

Another aspect of this disclosure provides a tilt tower, including a mast fixed to ground; a swing arm; and a bearing rotatably coupling the swing arm to a side of an upper end of the mast, the bearing including: a bearing seat coupled to the side of the upper end of the mast, the bearing seat including a first portion including a first hemispherical bearing surface and a second portion including a second hemispherical bearing surface, an axle coupled to an exterior surface of the first swing arm, wherein the axle includes a hollow interior portion connected to the interior of the first swing arm, and a sealed roller bearing between the axle and the mast.

Another aspect of the disclosure includes any of the preceding aspects, and the seat is physically connected to the mast by at least two fasteners and is selectively removable from the side of the mast.

Another aspect of the disclosure includes any of the preceding aspects, and the first portion and the second portion collectively form a circular bearing surface.

Another aspect of the disclosure includes any of the preceding aspects, and the first hemispherical bearing surface includes a first arc length different from a second arc length of the second hemispherical bearing surface.

Another aspect of the disclosure includes any of the preceding aspects, and the first portion of the bearing seat is permanently fixed to the side of the upper end of the mast and the second portion of the first bearing seat is selectively removable from the side of the upper end of the mast.

Another aspect of this disclosure provides a tilt tower, comprising: a mast fixed to the ground; a first swing arm having a first end opposite a second end; a first bearing rotatably coupling the first swing arm to a first side of an upper end of the mast; and a first adjustable counterweight system in an interior of the second end of the first swing arm.

Another aspect of the disclosure includes any of the preceding aspects, and the first adjustable counterweight system includes a first elongated member within the interior of the first swing arm and configured to receive a first plurality of weights.

Another aspect of the disclosure includes any of the preceding aspects, and the first elongated member extends at least partially along a longitudinal extent of the swing arm.

Another aspect of the disclosure includes any of the preceding aspects, and each weight in the first plurality of weights are immediately adjacent one another.

Another aspect of the disclosure includes any of the preceding aspects, and the first elongated member includes a threaded rod.

Another aspect of the disclosure includes any of the preceding aspects, and the first adjustable counterweight system includes an actuator operatively coupled to the first elongated member and allowing adjustment of a position of the first plurality of weights along the threaded rod.

Another aspect of the disclosure includes any of the preceding aspects, and the adjustable counterweight system includes a carrier operatively coupled to the first elongated member, the carrier configured to support the first plurality of weights, where each weight in the first plurality of weights is substantially U-shaped and a bottommost weight contacts the carrier.

Another aspect of the disclosure includes any of the preceding aspects, and further comprising an opening in the pivot end of the first swing arm, the opening configured to allow a respective weight of the first plurality of weights to be added or removed from the first elongated member of the first adjustable counterweight system.

Another aspect of the disclosure includes any of the preceding aspects, and further comprising a rotation limiter including: a first member extending radially from an exterior surface of an axle of the first bearing; a second member extending from the mast at a position to engage the first member at a first predetermined rotational angle of the swing arm relative to the mast in a first rotational direction; and a first energy absorber element on at least one of the first member and the second member to absorb energy in response to the first swing arm rotating to the predetermined rotational angle and the first member and the second member engaging to prevent further rotation.

Another aspect of the disclosure includes any of the preceding aspects, and further comprising a third member extending from the axle at a position to engage a fourth member extending from the mast at a second predetermined rotational angle of the first swing arm relative to the mast in a second, opposite rotational direction to the first rotational direction; and a second energy absorber element on at least one of the third member and the fourth member to absorb energy in response to the first swing arm rotating to the second predetermined rotational angle and the third member and the fourth member engage to prevent further rotation.

Another aspect of the disclosure includes any of the preceding aspects, and further comprising: a second swing arm; a second bearing rotatably coupling the second swing arm to a second side of the upper end of the mast opposite the first side of the upper end of the mast; and a second adjustable counterweight system in an interior of a proximal end of the second swing arm and including a second elongated member fixed within the interior of the second swing arm and configured to receive a second plurality of weights.

Another aspect of the disclosure includes any of the preceding aspects, and further comprising a locking assembly coupling a proximal end of the second swing arm to a lower end of the mast, wherein the locking assembly includes: a first member coupled to the lower end of the mast; a second member coupled to the proximal end of the second swing arm; and a removable fastener for selectively coupling the first member to the second member to lock the second swing arm relative to the mast in an operative position of the tilt tower, and removable to allow rotation of the second swing arm relative to the mast.

Another aspect of this disclosure provides a tilt tower, including a mast fixed to the ground; a swing arm having a first end opposite a second end; a bearing rotatably coupling the swing arm to a side of an upper end of the mast, and an adjustable counterweight system in an interior of the second end of the swing arm, the adjustable counterweight system including: an elongated member fixed within the interior of the swing arm and configured to receive a plurality of weights, an actuator coupled to the elongated member to allow adjustment of a position of the plurality of weights along the elongated member.

Another aspect of the disclosure includes any of the preceding aspects, and the elongated member extends at least partially along a longitudinal extent of the swing arm.

Another aspect of the disclosure includes any of the preceding aspects, and the elongated member is substantially cylindrical.

Another aspect of the disclosure includes any of the preceding aspects, and each weight in the plurality of weights includes a substantially circular exterior profile.

Another aspect of the disclosure includes any of the preceding aspects, and the elongated member includes a threaded rod, and wherein the actuator moves a carrier longitudinally along the threaded rod.

Another aspect of the disclosure includes any of the preceding aspects, and further comprising a rotation limiter including: a first member extending radially from an exterior surface of an axle of the bearing; a second member extending from the mast at a position to engage the first member at a first predetermined rotational angle of the swing arm relative to the mast in a first rotational direction; and a first energy absorber element on at least one of the first member and the second member to absorb energy in response to the swing arm rotating to the predetermined rotational angle and the first member and the second member engaging to prevent further rotation.

Another aspect of the disclosure includes any of the preceding aspects, and further comprising a third member extending from the axle at a position to engage a fourth member extending from the mast at a second predetermined rotational angle of the first swing arm relative to the mast in a second, opposite rotational direction to the first rotational direction; and a second energy absorber element on at least one of the third member and the fourth member to absorb energy in response to the first swing arm rotating to the second predetermined rotational angle and the third member and the fourth member engage to prevent further rotation.

Another aspect of this disclosure provides a tilt tower, including a mast fixed to the ground; a first swing arm having a first end opposite a second end; a first bearing rotatably coupling the first swing arm to a first side of an upper end of the mast: a first adjustable counterweight system in an interior of the second end of the first swing arm, including: a first elongated member within the interior of the first swing arm and configured to receive a first plurality of weights, and a first actuator coupled to the elongated member to allow adjustment of a position of the first plurality of weights along the first elongated member, a second swing arm having a first end opposite a second end; a second bearing rotatably coupling the second swing arm to a second side of the upper end of the mast opposing the first side of the upper end of the mast, wherein the second side is positioned on the mast vertically closer to the ground than the first side; and a second adjustable counterweight system in an interior of the second end of the second swing arm and including: a second elongated member within the interior of the second swing arm and configured to receive a second plurality of weights, and a second actuator coupled to the elongated member to allow adjustment of a position of the second plurality of weights along the second elongated member.

Another aspect of the disclosure includes any of the preceding aspects, and a tilt tower, comprising: a mast fixed to ground; a first swing arm; a first bearing rotatably coupling the first swing arm to a first side of an upper end of the mast; a second swing arm; and a second bearing rotatably coupling the second swing arm to a second side of the upper end of the mast opposing the first side of the upper end of the mast.

Another aspect of the disclosure includes any of the preceding aspects, and the first bearing and the second bearing each include: a bearing seat coupled to a respective side of the upper end of the mast; an axle coupled to an exterior surface of the respective swing arm, wherein each bearing seat includes a first portion including a first hemispherical bearing surface and a second portion including a second hemispherical bearing surface, wherein the first portion and the second portion collectively form a respective circular bearing surface; and a sealed roller bearing between the respective axle and the respective bearing seat.

Another aspect of the disclosure includes any of the preceding aspects, and the first portion of each bearing seat is permanently fixed to the respective side of the upper end of the mast, and the second portion of each bearing seat is selectively removable from the respective side of the upper end of the mast.

Another aspect of the disclosure includes any of the preceding aspects, and each axle includes a hollow interior, and each swing arm includes a tube having an interior, wherein the hollow interior of the respective axle is open to the interior of the tube of the respective swing arm through an opening in a side of the respective swing arm.

Another aspect of the disclosure includes any of the preceding aspects, and each axle includes a flange extending radially from a surface of each respective axle and at an end of each respective axle, and wherein each bearing seat at least partially encloses the respective flange.

Another aspect of the disclosure includes any of the preceding aspects, and further comprising a rotation limiter including: a first member extending radially from an exterior surface of a respective axle; a second member extending from the mast at a position to engage the first member at a first predetermined rotational angle of a respective swing arm relative to the mast in a first rotational direction; and a first energy absorber element on one of the first member and the second member to absorb energy when the respective swing arm rotates to the predetermined rotational angle and the first member and the second member meet to prevent further rotation.

Another aspect of the disclosure includes any of the preceding aspects, and the first swing arm and the second swing arm include a substantially rectangular cross-sectional area.

Another aspect of the disclosure includes any of the preceding aspects, and the first swing arm and the second swing arm have different lengths.

Another aspect of the disclosure includes any of the preceding aspects, and at least one of the first and second swing arms is a single structure.

Another aspect of the disclosure includes any of the preceding aspects, and at least one of the first and second swing arms includes at least two tubular structures, wherein the two tubular structures are telescopically coupled.

Another aspect of this disclosure provides a tilt tower, comprising: a mast fixed to ground; a first swing arm; a first bearing rotatably coupling the first swing arm to a first side of an upper end of the mast; a second swing arm; a second bearing rotatably coupling the second swing arm to a second side of the upper end of the mast opposing the first side of the upper end of the mast; and a locking assembly coupling a respective swing arm to the mast, wherein each locking assembly includes: a first member coupled to the mast; a second member coupled to the respective swing arm; and a removable fastener for selectively coupling the first member to the second member to lock the respective swing arm relative to the mast in an operative position of the tilt tower, and removable to allow rotation of the respective swing arm relative to the mast.

Another aspect of the disclosure includes any of the preceding aspects, and the first bearing is coupled to the mast vertically above the second bearing and wherein the swing arms are different lengths.

Another aspect of the disclosure includes any of the preceding aspects, and the first swing arm and the second swing arm include a substantially rectangular cross-sectional area.

Another aspect of the disclosure includes any of the preceding aspects, and the first swing arm and the second swing arm have different lengths.

Another aspect of the disclosure includes any of the preceding aspects, and at least one of the first and second swing arms is a single structure.

Another aspect of the disclosure includes any of the preceding aspects, and at least one of the first and second swing arms includes at least two tubular structures, wherein the two tubular structures are telescopically coupled.

Another aspect of this disclosure provides a tilt tower, comprising: a mast fixed to ground; a first swing arm having a first length; a first bearing rotatably coupling the first swing arm to a first side of an upper end of the mast; a second swing arm having a second length less than the first length; a second bearing rotatably coupling the second swing arm to a second side of the upper end of the mast opposing the first side of the upper end of the mast; and an adjustable counterweight system in an interior of an end of each swing arm.

Another aspect of the disclosure includes any of the preceding aspects, and each adjustable counterweight system includes: an elongated member within an interior of each respective swing arm and configured to receive a plurality of weights; and an actuator operatively coupled to the elongated member and allowing adjustment of a position of the respective plurality of weights along a respective elongated member.

Another aspect of the disclosure includes any of the preceding aspects, and the respective elongated member extends partially along a longitudinal extent of the respective swing arm.

Another aspect of the disclosure includes any of the preceding aspects, and further comprising an opening in each swing arm, each opening configured to allow a weight of the respective plurality of weights to be added or removed from the respective elongated member of the respective adjustable counterweight system.

Two or more aspects described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a side view of a tilt tower in an operative position of a swing arm thereof, according to embodiments of the disclosure;

FIG. 2 shows an elevation view of a tilt tower in a lowered, access position of a swing arm thereof, according to embodiments of the disclosure;

FIG. 3 shows a top-down, partially cross-sectional view along view line 3-3 in FIG. 1, according to embodiments of the disclosure;

FIG. 4A shows an enlarged side view of an upper end of a mast and swing arm, according to embodiments of the disclosure;

FIG. 4B shows an enlarged and partially exploded side view of an axle, according to embodiments of the disclosure;

FIG. 5A shows a perspective view of an axle and bearing, according to embodiments of the disclosure;

FIG. 5B shows an enlarged side view of an upper end of a mast and swing arm, according to embodiments of the disclosure;

FIG. 5C shows a partially exploded perspective view of an axle and a bearing along view lines 5C-5C in FIG. 5A, according to embodiments of the disclosure;

FIG. 5D shows perspective cross-sectional view of a bearing according to embodiments of the disclosure.

FIG. 6 shows a cross-sectional view along view line 6-6 in FIG. 1, according to embodiments of the disclosure;

FIG. 7 shows a top-down view along view line 7-7 in FIG. 1, according to embodiments of the disclosure;

FIG. 8 shows a side view along view line 8-8 in FIG. 1, according to embodiments of the disclosure;

FIG. 9 shows a side view along view line 9-9 in FIG. 1, according to embodiments of the disclosure;

FIGS. 10A-B show side views along view line 10-10 in FIG. 1, according to embodiments of the disclosure;

FIG. 11A shows a side view along view line 11A-11A in FIG. 2, according to embodiments of the disclosure;

FIG. 11B shows a cross-sectional view of the structure in FIG. 11A, according to embodiments of the disclosure;

FIG. 12 shows a see-through, side view along view line 12-12 in FIG. 1, according to embodiments of the disclosure;

FIG. 13 shows a side view along view line 13-13 in FIG. 2, according to embodiments of the disclosure;

FIG. 14 shows a side view of a tilt tower in an operative position of two swing arms thereof, according to other embodiments of the disclosure;

FIG. 15 shows an elevation view of a tilt tower in lowered, access positions of two swing arms thereof, according to other embodiments of the disclosure;

FIG. 16 shows a top-down view along view line 16-16 in FIG. 14;

FIG. 17A shows an enlarged side view of an adjustable counterweight system, according to other embodiments of the disclosure;

FIG. 17B shows an enlarged perspective view of an adjustable counterweight system with U-shaped weights, according to other embodiments of the disclosure;

FIG. 17C shows an enlarged side view of an adjustable counterweight system, according to other embodiments of the disclosure;

FIG. 18 shows a schematic view of a bearing seat, according to other embodiments of the disclosure; and

FIG. 19 shows a schematic view of a bearing seat, according to other embodiments of the disclosure.

It is noted that the drawings of the disclosure are not necessarily to scale. The drawings are intended to depict only typical aspects of the disclosure and therefore should not be considered as limiting the scope of the disclosure. In the drawings, like numbering represents like elements between the drawings.

### DETAILED DESCRIPTION

As an initial matter, in order to clearly describe the current disclosure, it will become necessary to select certain terminology when referring to and describing relevant machine components within the illustrative application of a utility tower. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

In addition, several descriptive terms may be used regularly herein, and it should prove helpful to define these terms at the onset of this section. These terms and their definitions, unless stated otherwise, are as follows. As used herein, “proximal” and “distal” are terms that indicate a location of a structure relative to a point of reference, such as an end of a swing arm of a tilt tower that may change location during operation. The term “proximal” corresponds to a structure typically closer to the viewer, and the term “distal” refers to a location typically farther from the viewer.

It is often required to describe parts that are at different radial positions with regard to a center axis. The term “axial” refers to movement or position parallel to an axis, e.g., a rotational axis of a tilt tower. The term “radial” refers to movement or position perpendicular to an axis, e.g., an axle of a swing arm of a tilt tower. In cases such as this, if a first component resides closer to the axis than a second component, it will be stated herein that the first component is “radially inward” or “inboard” of the second component. If, on the other hand, the first component resides further from the axis than the second component, it may be stated herein that the first component is “radially outward” or “outboard” of the second component. Finally, the term “circumferential” refers to movement or position around an axis, e.g., a circumferential exterior surface of an axle of a tilt tower. As indicated above, it will be appreciated that such terms may be applied in relation to the axis of the turbomachine.

In addition, several descriptive terms may be used regularly herein, as described below. The terms “first,” “second,” and “third,” may be used interchangeably to distinguish one component from another and are not intended to signify location or importance of the individual components.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event may or may not occur or that the subsequently described feature may or may not be present and that the description includes instances where the event occurs, or the feature is present and instances where the event does not occur or the feature is not present.

Where an element or layer is referred to as being “on,” “engaged to,” “connected to,” “coupled to,” or “mounted to” another element or layer, it may be directly on, engaged, connected, coupled, or mounted to the other element or layer, or intervening elements or layers may be present. In contrast, when an element is referred to as being “directly on,” “directly engaged to,” “directly connected to,” or “directly coupled to” another element or layer, there are no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The verb forms of “couple” and “mount” may be used interchangeably herein.

Embodiments of the disclosure include a tilt tower. The tilt tower includes a mast fixed to ground, a swing arm including a tube with a hollow interior portion, and a bearing rotatably coupling the swing arm to a side of an upper end of the mast. The bearing includes a bearing seat coupled to the side of the upper end of the mast, an axle coupled to an exterior surface of the respective swing arm, where the axle includes a hollow interior portion connected to the interior of the tube of the swing arm, and a sealed roller bearing between the axle and the mast. Embodiments of the disclosure also include a tilt tower comprising: a mast fixed to the ground; a first swing arm having a first end opposite a second end; a first bearing rotatably coupling the first swing arm to a first side of an upper end of the mast; and a first adjustable counterweight system in an interior of the second end of the first swing arm. Embodiments of the disclosure also include a tilt tower including a mast fixed to ground, a first swing arm, and a first bearing rotatably coupling the first swing arm to a first side of an upper end of the mast. The tilt tower further includes a second swing arm and a second bearing rotatably coupling the second swing arm to a second side of the upper end of the mast opposing the first side of the upper end of the mast. The tilt tower with a bearing, as described herein, provides a sealed bearing that does not require as frequent lubrication and provides better frictional performance, ensuring reliable and easier operation of the swing arm. The hollow axle allows routing of wiring through the bearing. The tilt tower also reduces stress and fatigue, extending the lifespan of the tower, and allows for scaling for larger and taller applications, such as cell towers. The provision of two swing arms allows for addition of utility equipment beyond what is currently available. The adjustable counterweight system allows adjustment of the counterweights to maintain safe use of the tower by ensuring rotational balance.

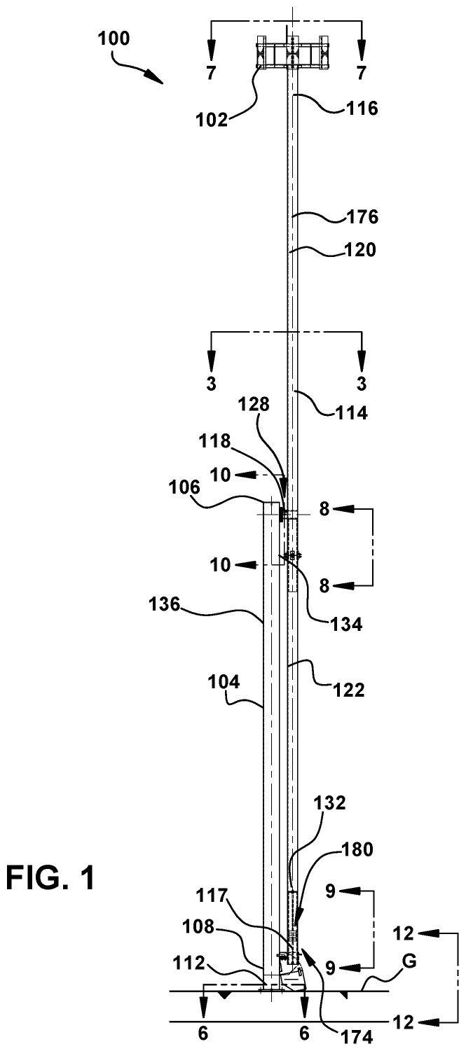

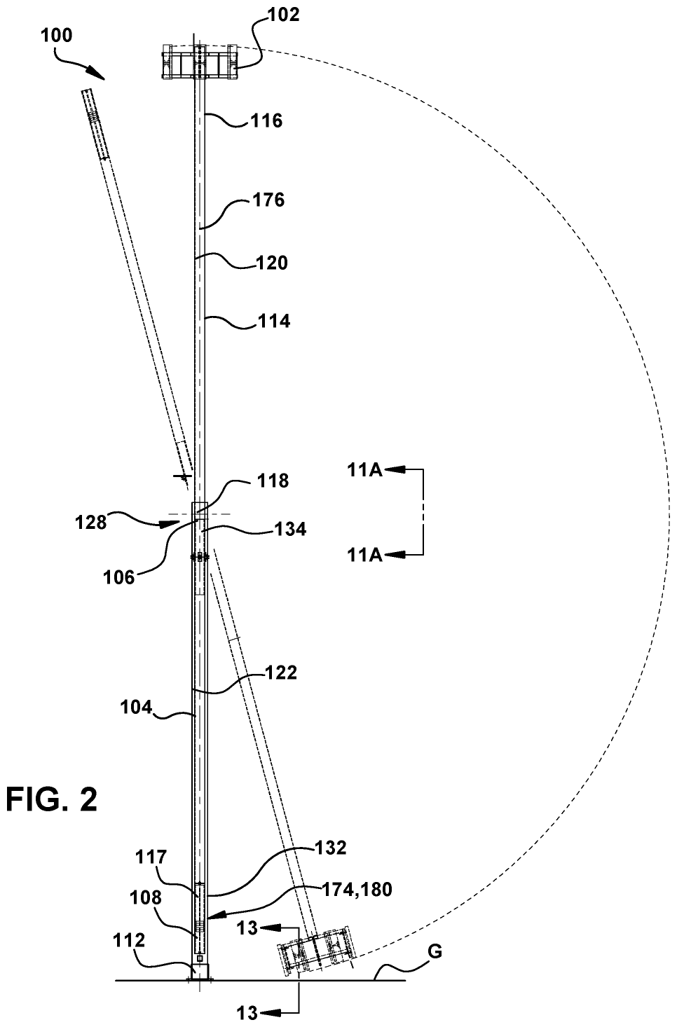

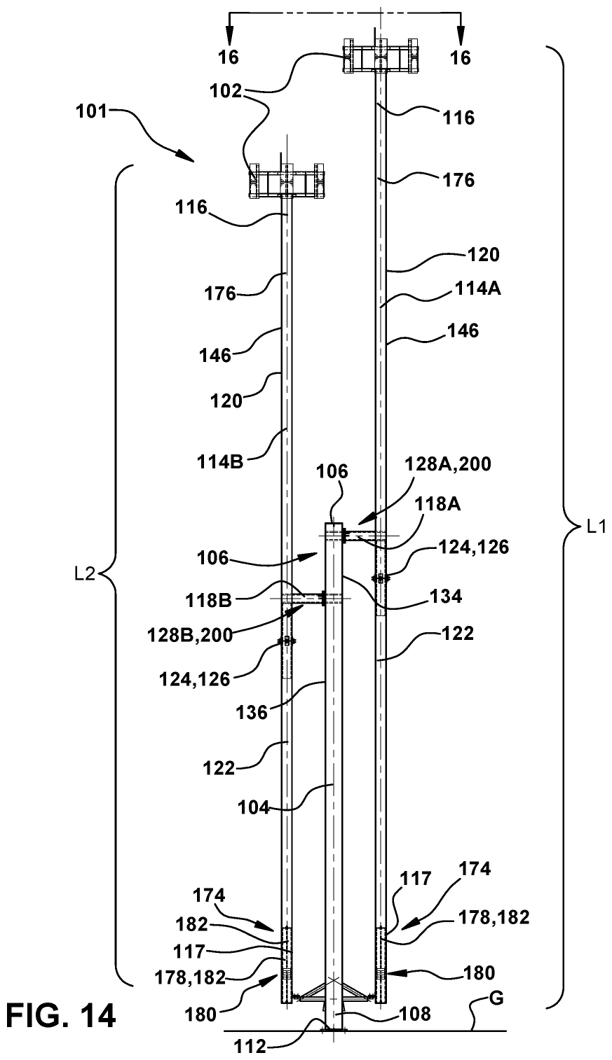

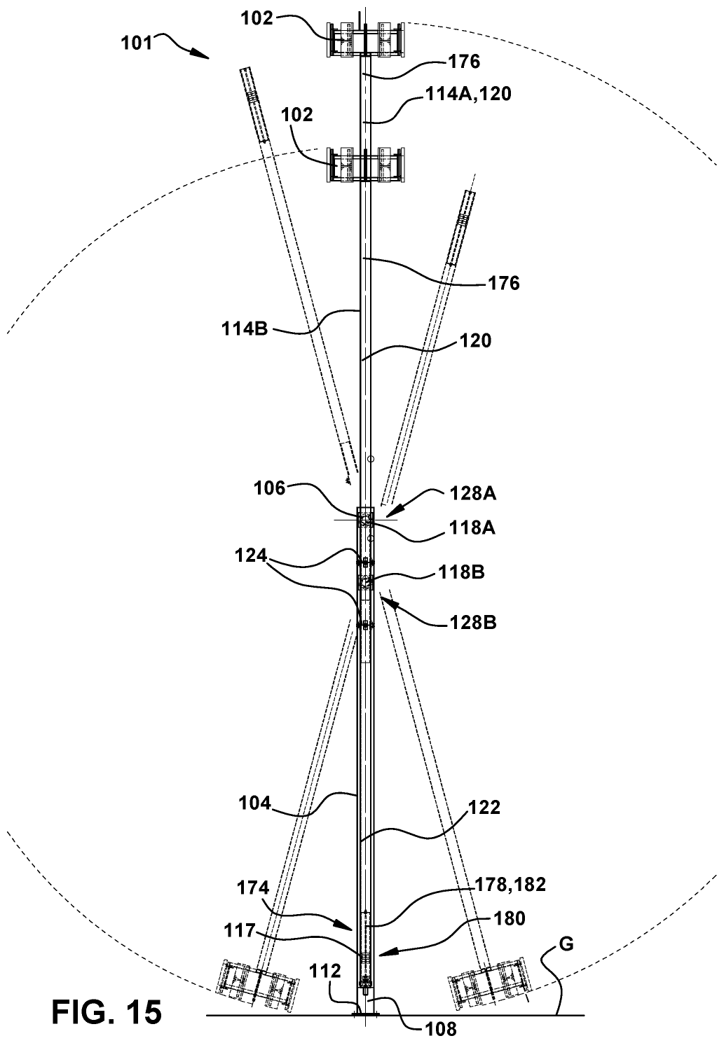

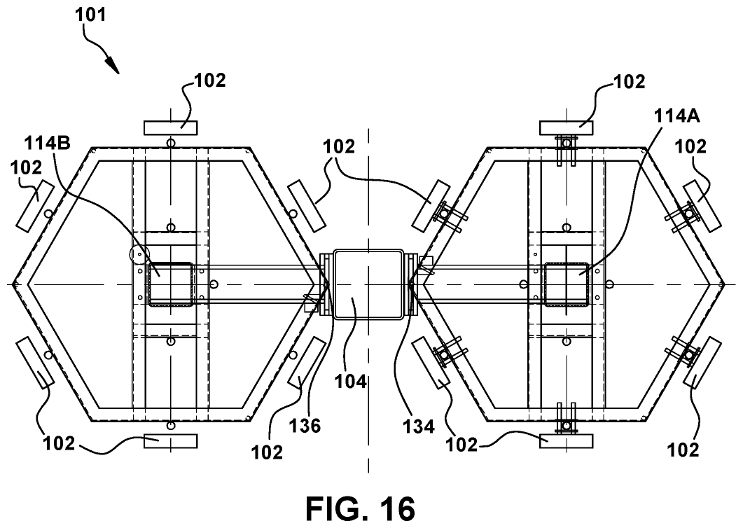

FIGS. 1 and 2 show side views of a tilt tower 100 according to embodiments of the disclosure, and FIGS. 14-15 show side views of a tilt tower 101 according to other embodiments of the disclosure. Tilt towers 100 and 101 may be, e.g., a utility tower used for telecommunications and may include utility equipment 102 mounted thereon. “Utility equipment” as used herein may include any now known or later developed items requiring elevated positioning, such as but not limited to: radio transceivers, cell transceivers, other telecommunications related items, antennas, weather sensors, flags and/or satellite dishes. Utility equipment 102 may be mounted using any now known or later developed mounting frames and lightning arrest equipment. FIG. 7 shows a top-down view along view line 7-7 in FIG. 1, and FIG. 16 shows a top-down view along view line 16-16 in FIG. 14, with tilt tower 101 including utility equipment 102 on both swing arms 114A and 114B, increasing the capacity of tilt tower 101. FIGS. 7 and 16 show various utility equipment 102 on tilt towers 100, 101, respectively.

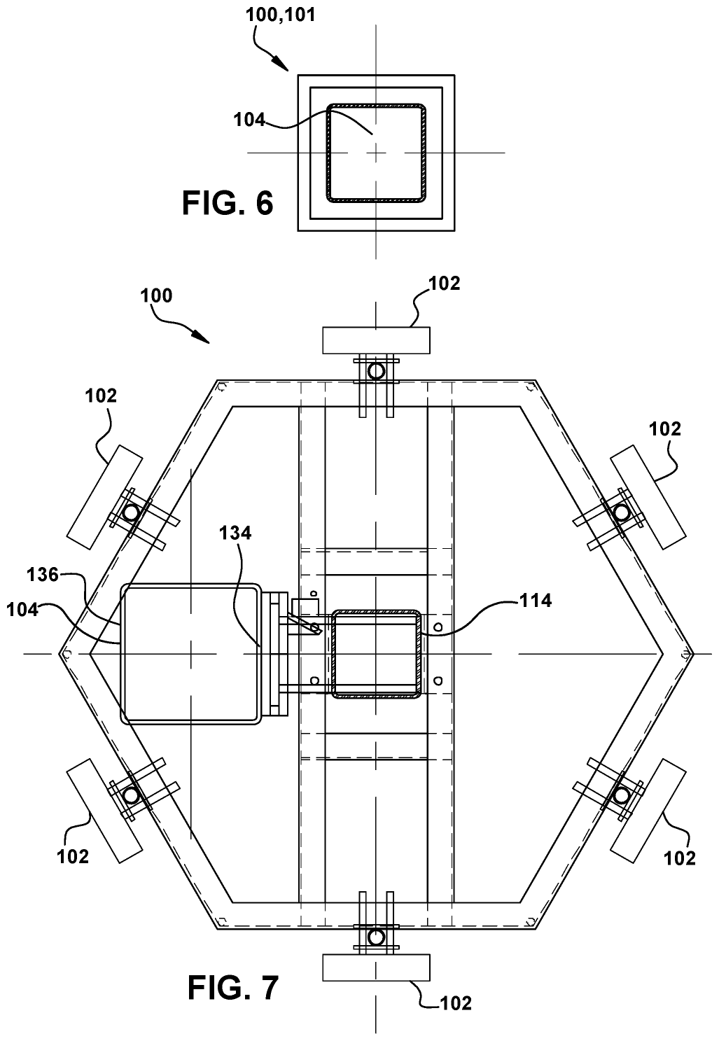

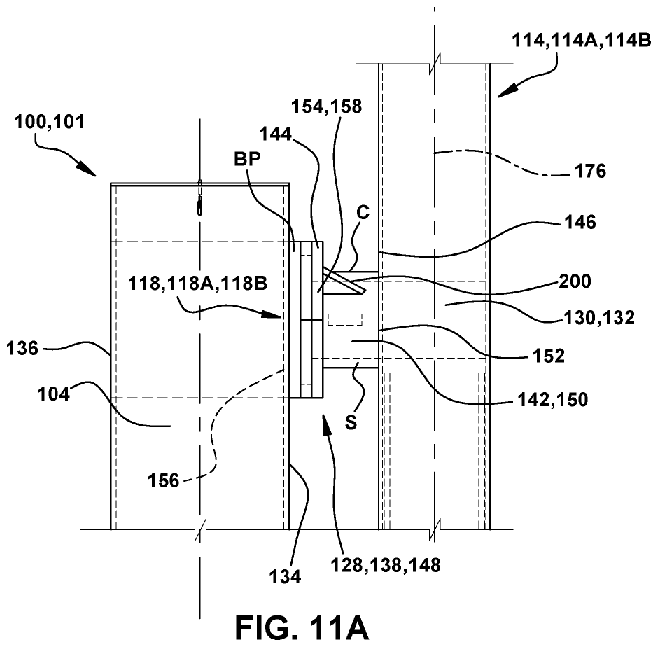

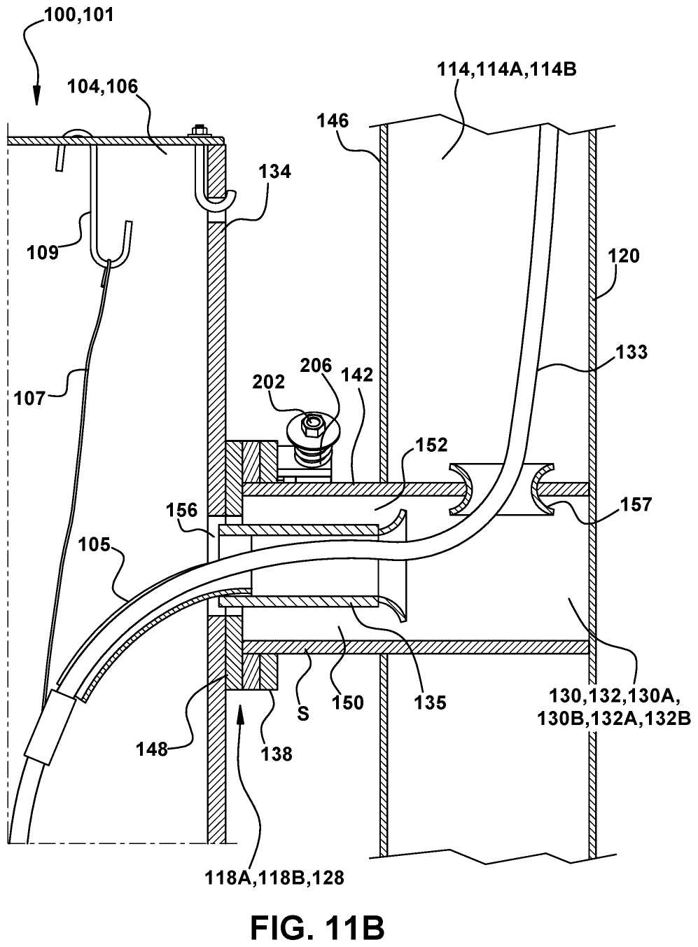

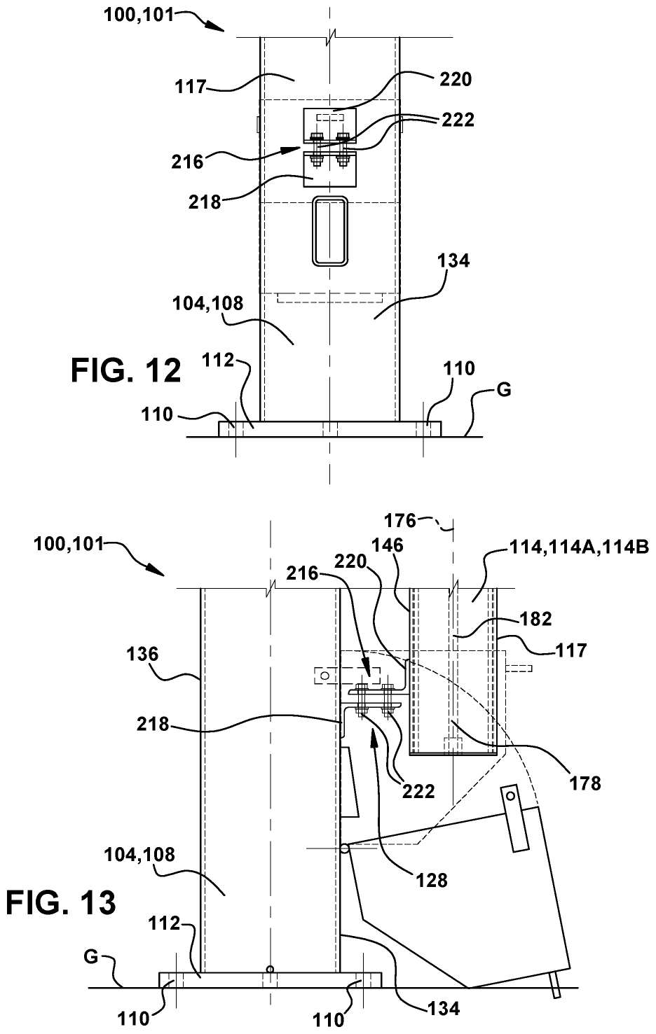

FIGS. 1-3 show various perspectives of tilt tower 100 and FIGS. 14-15 show various perspectives of tilt tower 101 according to embodiments of the disclosure. Tilt towers 100 and 101 may include a mast or a fixed tower base tube 104 (hereafter “mast 104”) fixed to ground G. Mast 104 may include an upper end 106 vertically above a lower end 108 (FIGS. 1-2, 14-15). FIGS. 12-13 show side views of lower end 108 of mast 104. Lower end 108 may be fixed to ground G (e.g., the earth or foundation therebelow) using any now known or later developed method or device for fixing mast 104 to ground through, e.g., as shown in FIGS. 12-13, fasteners 110 fixing adjustable base plate 112 to ground G. Mast 104 may include any durable material, e.g., metal, wood, capable of withstanding the stress and environment that tilt tower 100 may experience and may be of any feasible length or thickness. Mast 104 may take the form of, e.g., a tubular structure. FIG. 6 shows a cross-sectional view along view line 6-6 in FIG. 1 of mast 104. Mast 104 may have a square cross-section; however, other cross-sections, such as circular or rectangular are also possible. Mast 104 may provide mechanical support structure for other components in tilt tower 100. For example, mast 104 may include electrical wiring 105 (FIG. 11B) (referred to as simply “wires” or “wiring” herein) therein. As shown in FIG. 11B, wiring 105 may be connected through a support cable 107 to a hook 109 mounted within interior of mast 104. Support cable 107 may be, e.g., metal, and hook 109 may be any conceivable hook, e.g., a J-hook, and may include any material.

Tilt tower 100 may include a swing arm 114 having an operative or first end 116 (hereafter “first end 116”) opposite a second end 117. Swing arm 114 may allow lowering of first end 116 of tilt tower 100 for, e.g., maintenance and improvements. First end 116 may be the elevated end in an operative state (FIGS. 1-2 and 14-15) and may include utility equipment 102 attached thereto. In an operative state, first end 116 of swing arm 114 may be above a pivot point 118, i.e., a point along mast 104 where swing arm 114 may pivot around a point, and second end 117 is below pivot point 118 and near lower end 108 of mast 104. Pivot point 118 is at or near upper end 106 of mast 104. In an inoperative state, first end 116 of swing arm 114 may be rotated to be below pivot point 118 and adjacent ground G and lower end 108 of mast 104 for access by a user, and second end 117 may be rotated above pivot point 118.

In some embodiments, shown in FIGS. 14 and 15, tilt tower 101 may include a first swing arm 114A and a second swing arm 114B that each swing around a respective pivot point 118—two pivot points labeled 118A and 118B in FIGS. 14-15 for differentiation. Swing arms 114A and 114B may be substantially similar or even identical to swing arm 114 in other implementations. In some embodiments, shown in FIG. 14, first swing arm 114A may have a first length L1 and second swing arm 114B may have a second length L2 less than first length L1, i.e., first swing arm 114A and second swing arm 114B may be different lengths. The different lengths ensure utility equipment on ends 116 of each swing arm 114A, 114B do not interfere or collide with one another in use or during tilting.

With regard to the description of tilt towers 100 and 101 hereafter, it is understood that structure references as part of a single swing arm 114 arrangement of tilt tower 100 in FIGS. 1-2 may be used and/or duplicated in tilt tower 101 in FIGS. 14-15. Hence, some structure (shown by different view lines) of tilt tower 100 in FIG. 1 may also be applicable to tilt tower 101. In those cases, the drawings may include references 100 and 101 to indicate applicability to one or both embodiments.

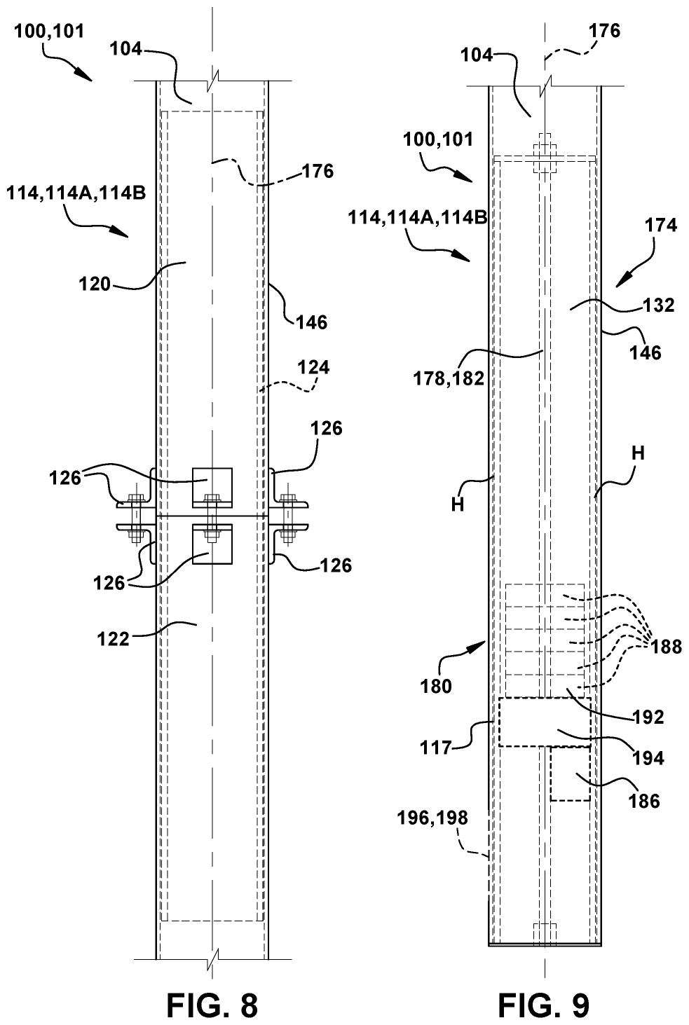

Each swing arm 114, 114A, and 114B may include any durable material (e.g., metal, wood) capable of withstanding the stress and environment tilt tower 100 may experience. Swing arms 114, 114A, and 114B may each take the form of a single structure, i.e., swing arms 114, 114A, and 114B may each be a unitary structure. Alternatively, as shown in FIG. 8, which shows a side view of a portion of tilt towers 100 and 101 along view line 8-8 in FIG. 1, swing arms 114, 114A, and 114B may each include a pair of tubular structures 120 and 122 arranged end-to-end and fixed together. In one non-limiting example, tubular structures 120 and 122 may be coupled together by a telescopically arranged splice member 124 fixed in place by, for example, bolted angle irons 126 on each tubular structure 120 and 122, or other fastening means. Swing arms 114, 114A, and 114B may each be substantially square in cross-section. “Substantially” here means within manufacturing tolerances. However, other shapes, such circular cross-sections (so the swing arms are cylindrical) or rectangular cross-sections, are possible.

Tilt tower 100 may include a bearing 128 rotatably coupling swing arm 114 to a side 134 of upper end 106 of mast 104. In some embodiments, shown in FIGS. 14-15, tilt tower 101 may include a first bearing 128A rotatably coupling first swing arm 114A to a first side 134 of upper end 106 of mast 104, and a second bearing 128B rotatably coupling second swing arm 114B to a second side 136 of upper end 106 of mast 104 opposing first side 134 of upper end 106 of mast 104. Bearings 128A, 128B may be substantially similar or even identical to one another. A bearing is a system to reduce friction and allows rotation of an object, e.g., swing arm 114, about an axis. More particularly, pivot points 118, 118A, and 118B may each include a bearing 128 about which swing arms 114, 114A, and 114B, respectively, may pivot, i.e., rotate. Swing arms 114, 114A, 114B may tilt any number of degrees at respective pivot point 118, 118A-B. For example, single swing arm 114 and/or dual swing arms 114A and 114B may each tilt between 0° and 360° (as shown, e.g., in FIGS. 2 and 15) relative to vertically perpendicular to ground G.

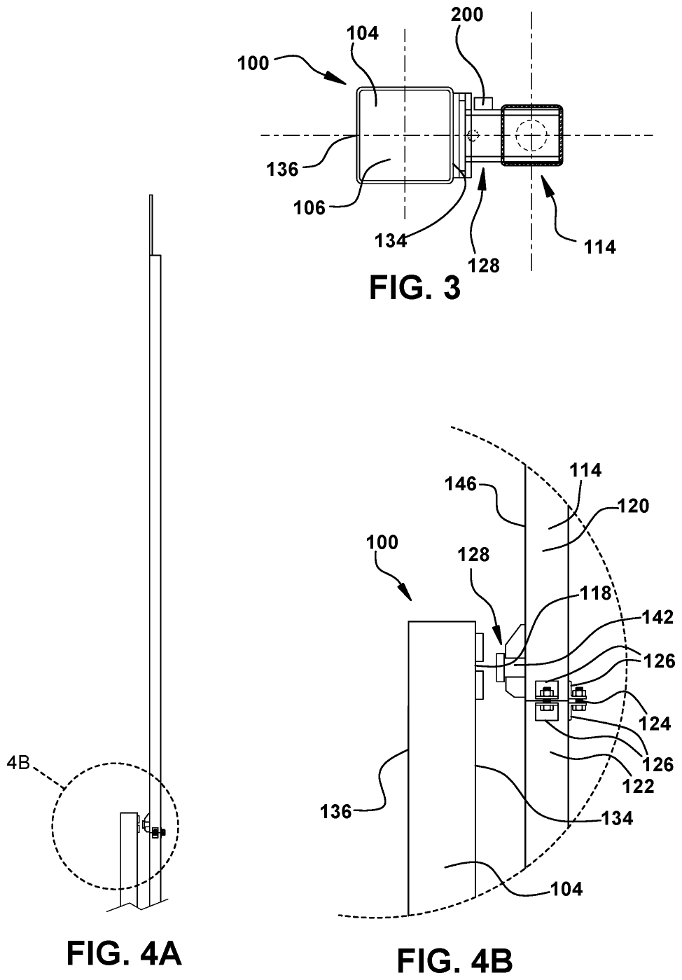

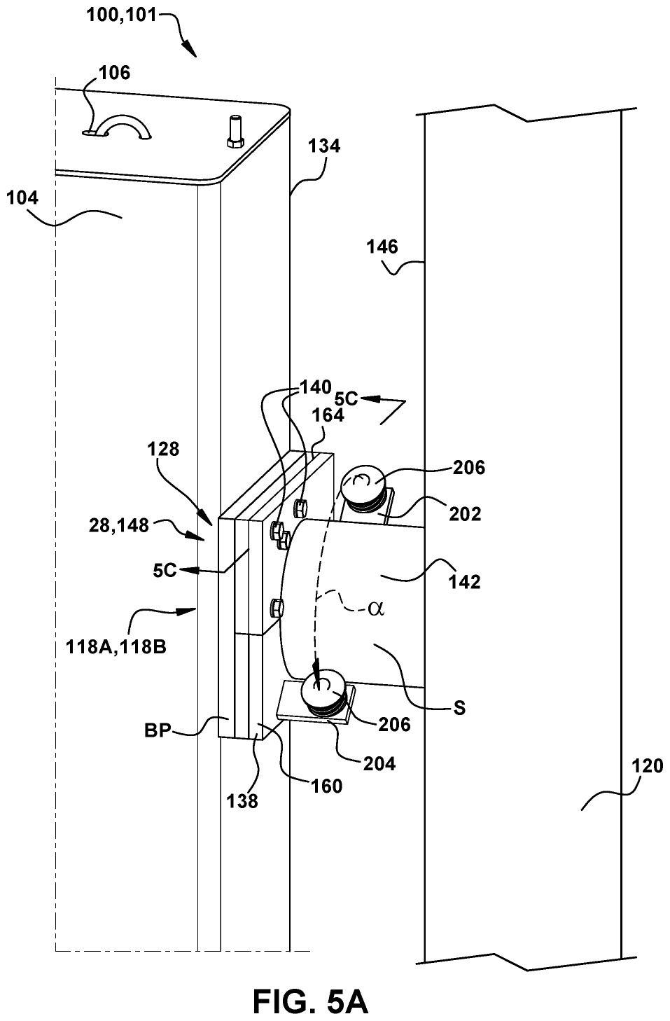

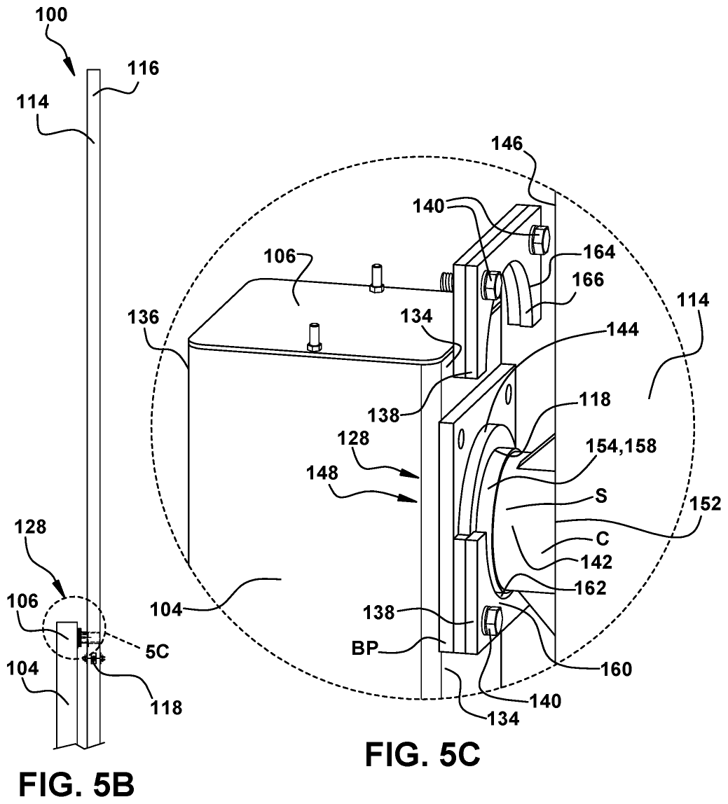

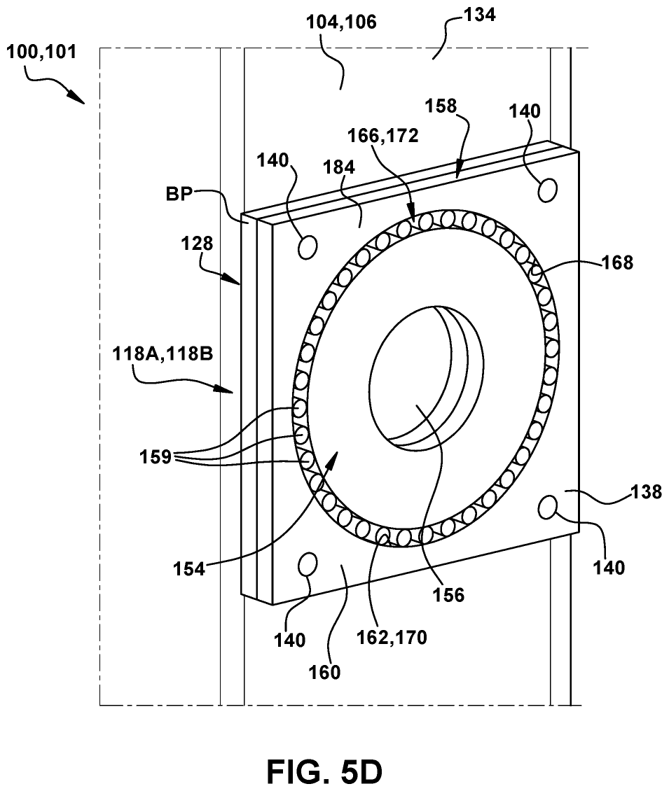

FIGS. 3-5C show various views of bearings 128. FIG. 3 shows a top-down view along view line 3-3 in FIG. 1 of bearing 128; FIG. 4 shows an enlarged and exploded side view of bearing 128; FIG. 5A shows a perspective view of bearing 128; FIG. 5B shows an exploded perspective view of bearing 128; and FIG. 5C shows a cross-sectional view along view line 5C-5C in FIG. 5A, according to embodiments of the disclosure. In embodiments where tilt tower 100 includes swing arm 114, bearing seat 138 may be coupled to side 134 of upper end 106 of mast 104. Bearing seat 138 of bearing 128 may be physically connected to side 134 of upper end 106 of mast 104 by at least two fasteners 140. More particularly, bearing seats 138 may be physically connected to side 134 of mast 104 by at least two fasteners 140 (FIG. 5). Accordingly, bearing seats 138 may be selectively removable from side 134 of mast 104 by, e.g., removing fasteners 140. Bearing seats 138 may alternatively be permanently fixed to mast 104 by, e.g., welding. As shown in FIGS. 14 and 15, second pivot point 118B of second swing arm 114B may be positioned on mast 104 vertically closer to ground G than pivot point 118A of first swing arm 114A. Consequently, a bearing 128A of first swing arm 114A may be coupled to mast 104 vertically above bearing 128B of second swing arm 114B. Bearings 128 represent a structural improvement to the current pivot design to reduce stresses on bearings 128 and improvements in fatigue performance. Referring to FIGS. 3-5C, each bearing 128, 128A, 128B may include a bearing seat 138 coupled to sides 134 or 136 of mast 104. A bearing seat (also known in the art as a “bearing housing” or “bearing pedestal”) is a component that mechanically supports and/or positions a bearing relative to a machine. In embodiments where tilt tower 101 includes first swing arm 114A and second swing arm 114B, as shown in FIG. 14, bearings 128, as shown in FIGS. 5A-C, may be used on both sides 134, 136 of mast 104. More particularly, first swing arm 114A may include bearing 128A including bearing seat 138 coupled to side 134 of upper end 106 of mast 104 and second swing arm 114B may include bearing 128B including bearing seat 138 coupled to side 136 of mast 104. Bearing seats 128 are substantially similar, or even identical, to bearing seat 128 in other implementations. Bearing seat 138 of bearing 128A may be physically connected to side 134 of upper end 106 of mast 104 by at least two fasteners 140 and bearing seat 138 of bearing 128B may be selectively removable from side 136 of mast 104. More particularly, bearing seats 138 may be physically connected to respective sides 134 and 136 of mast 104 by at least two fasteners 140 (FIGS. 5A-C). Accordingly, bearing seats 138 may be selectively removable from respective first side 134 or second side 136 of mast 104 by, e.g., removing fasteners 140. Bearing seats 138 may alternatively be permanently fixed to mast 104 by, e.g., welding.

Still referring to FIGS. 4 and 5A-B, bearing 128 may include axle 142 coupled to an exterior surface 146 of a respective swing arm 114. In some embodiments, shown in FIGS. 14 and 15, bearings 128 may include axles 142 coupled to exterior surfaces 146 of respective swing arms 114A and 114B. In such embodiments, axles 142 may be substantially similar or even identical to axles 142 in other implementations. In any case, axles 142 may provide mechanical linkage between bearings 128 and their respective swing arms 114, 114A, and 114B. Axles 142 may be welded to respective exterior surfaces 146 of swing arms 114, 114A, and 114B in any appropriate manner. Notably, axles 142 may reduce stresses at respective joints 148 (where axles 142 meet mast 104), improve fatigue performance, reduce the number of fabricated pieces at joints 148 (no stiffeners), or reduce the amount of critical welding. Axles 142 may include any material capable of withstanding stress and the environment to which it is exposed, e.g., steel or other alloys.

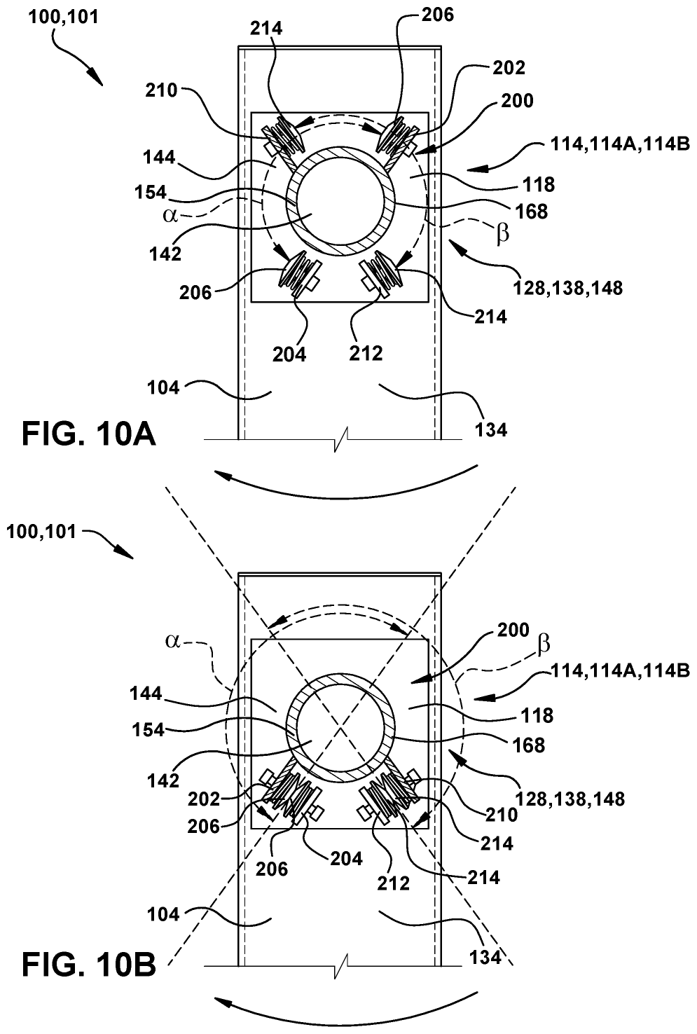

FIGS. 10A-B show side views of axle 142 along view line 10-10 in FIG. 1; FIG. 11A shows a side view of axle 142 along view line 11-11 in FIG. 2; and FIG. 11B shows a cross-sectional view of axle 142, according to various embodiments. As shown in FIGS. 11A-B, in some embodiments, each swing arm 114 may include a tube 130 with a hollow interior portion 132. Hollow interior portion 132 may allow, e.g., electrical wiring 105 (FIG. 11B) to be placed therethrough. As shown in FIG. 11B, which shows a cross-sectional view of bearings 128 in FIG. 11A, tube 130 may include a pipe sleeve 135 to support wiring 105. Pipe sleeve 135 may be made of any durable material, and may include a frusto-conical cross-sectional end area. Similarly, swing arms 114A and 114B may each include respective tubes 130A and 130B with hollow interior portions 132A and 132B. As also shown in FIGS. 11A-B, axles 142 may include a hollow interior portion 150 connected to or coextensive with interior portion 132 of tube 130 of swing arm 114. Hollow interior portion 150 may be open space in axle 142 through which materials may be inserted. Hollow interior portion 150 of axle 142 may be open to hollow interior portion 132 of tube 130 of swing arm 114 through an opening 152 inside of swing arm 114. Similarly, hollow interior portions 150 of axles 142 may be open to the hollow interior portions 132 of tubes 130 of swing arms 114A and 114B through openings 152 in respective sides 146 of swing arms 114A and 114B. Hollow interior portions 132, 150 allow wiring 133 to extend through any swing arms 114, 114A and 114B, a respective bearing 128, and into mast 104. As mentioned previously, wiring 105 may be connected through support cable 107 to hook 109 (FIG. 11B) mounted within interior of mast 104. A cable grommet 157 may be within hollow interior portion 132 of swing arm 114, 114A, 114B through which wires 133 may extend into swings arms 114, 114A, and 114B. Cable grommet 157 may be any durable material, and may include, e.g., a flanged, flared or frusto-conical portion.

In some implementations, axles 142 may be cylindrical and may include a uniform circumference C (FIGS. 5B, 10A-B, and 11A) throughout the length of axles 142. As discussed previously, axles 142 may include a respective flange 144 (FIGS. 5A, 10A-B, and 11A) extending radially from axle surface S (FIGS. 11A-B) and may be connected to mast 104 through sealed roller bearings 154 and bearing seats 138. Similarly, axles 142 may each include respective flanges 144 extending radially from a respective axle surface S (FIGS. 11A-B) and may be connected to swing arms 114, 114A, and 114B. As shown in FIGS. 5A-B and 11A, flanges 144 may be operatively coupled to a backing plate BP between flanges 144, and mast 104. Backing plate BP may be a raised portion of durable material fixed to mast 104 to provide material for flanges 144 to be fixed to. In one embodiment, shown in FIG. 5, bearing seats 138 may each be at least partially about respective flanges 144.

Referring to FIGS. 5A-C, each bearing 128 may include a sealed roller bearing 154 between axle 142 and mast 104. A bearing reduces friction between moving parts, as discussed previously, and a sealed roller bearing, in particular, is a bearing with built-in seals to protect internal rotational components from contaminants and prevent loss or breakdown of lubricants. Similarly, each bearing 128 in swings arms 114A and 114B may each include sealed roller bearings 154 between axle 142 and bearing seat 138. Sealed roller bearings 154 in swing arms 114A and 114B may be substantially similar or even identical to sealed roller bearings 154 in other implementations. In some implementations, sealed roller bearing 154 may be at least partially within bearing seat 138 of bearing 128. Similarly, sealed roller bearings 154 may be at least partially within bearing seats 138, i.e., bearing seats 138 may mechanically support or affix sealed roller bearings 154. Further, each sealed roller bearings 154 may at least partially be within openings 156 (FIGS. 11A-B) in mast 104. Sealed roller bearings 154 may each include a roller bearing assembly (not shown) attached to respective axles 142 and installed on respective swing arms 114, 114A, and 114B. In one implementation, sealed roller bearing 154 may take the form of a spherical sealed roller bearing 158 (FIG. 5C). A spherical sealed roller bearing is a roller bearing including inner and outer rings with spherical or cylindrical rollers 159 therebetween. Similarly, in embodiments with swing arms 114A and 114B, as shown in FIGS. 14 and 15, sealed roller bearings 154 may take the form of spherical sealed roller bearings 158. Spherical sealed roller bearings 158 in swing arms 114A and 114B are substantially similar or even identical to spherical sealed roller bearings 158 in other implementations. The sealed roller bearings 154 discussed herein improve upon conventional pivot structures and reduce friction of the pivot assembly to improve operational performance and decrease maintenance.

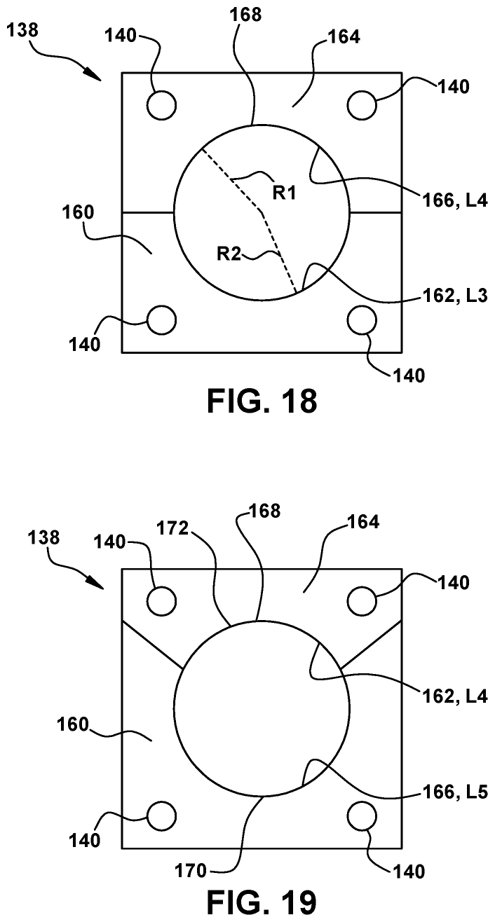

FIG. 18 shows a schematic view of a bearing seat 138, and FIG. 19 shows a schematic view of a bearing seat 138, according to various embodiments of the disclosure. Referring to FIGS. 5A-C and 18, bearing seat 138 may include a first portion 160 including a first hemispherical bearing surface 162 and a second portion 164 including a second hemispherical bearing surface 166. First portion 160 and second portion 164 may collectively form a respective circular bearing surface 168 (FIG. 18) about sealed roller bearings 154 (FIGS. 5A-C). In such embodiments, as shown in FIGS. 5A-C, first portion 160 and second portion 164 are each between respective axles 142 and mast 104. More particularly, first and second portions 160, 164 are around axle 142 next to mast 140. Similarly, in embodiments including two swings arms 114A and 114B, as shown in FIGS. 14 and 15, each bearing seat 138 may include a first portion 160 and a second portion 164, with first portions 160 each including first hemispherical bearing surfaces 162 and second portions 164 each including second hemispherical bearing surfaces 166. First portions 160, second portions 164, first hemispherical portions 162, and second hemispherical portions 166 are substantially similar or even identical between implementations. Hemispherical portions 162 and 166 may be durable components that may be joined together to form, e.g., circular bearing surface 168. Hemispherical portions 162 and 166, may include any durable material, including, for example, metals or hard plastics. As shown in FIGS. 5A-B, first portion 160 may be permanently fixed to mast 104 by, e.g., by bolts/fasteners 140 and/or welding. Alternatively, or additionally, second portion 164 of bearing seat 138 may be selectively removable from mast 104. Similarly, first portion 160 of bearing seats 138 may be permanently fixed to respective sides 134 or 136 of mast 104, e.g., by bolts/fasteners 140 and/or welding, to allow for repair/access of bearing. In FIG. 18, first hemispherical bearing surfaces 162 may include a first arced surface having a first arc length L3 and second hemispherical bearing surfaces 166 may include a second arced surface having a second arc length L4, where arc lengths L3 and L4 are equal, i.e., L3-L4. First portions 160 of bearing seats 138, may be permanently fixed to respective sides 134 and 136 of mast 104 and second portions 164 of bearing seats 138 may be selectively removable from respective sides 134 and 136 of mast 104. In FIG. 18, first hemispherical bearing surface 162 may have a first radius R1 and second hemispherical bearing surfaces 166 may have a second radius R2 substantially equal to first radius R1, i.e., R1=R2. In contrast in FIG. 19, bearing surfaces are not hemispherical. In FIG. 19, a first arced surface 170 has a first arc length L4 different from a second arc length L5 of a second arced surface 172. Nonetheless, first portion 160 and second portion 164 may collectively form a respective circular bearing surface 168 (FIG. 19) about sealed roller bearings 154 (FIGS. 5A-C).

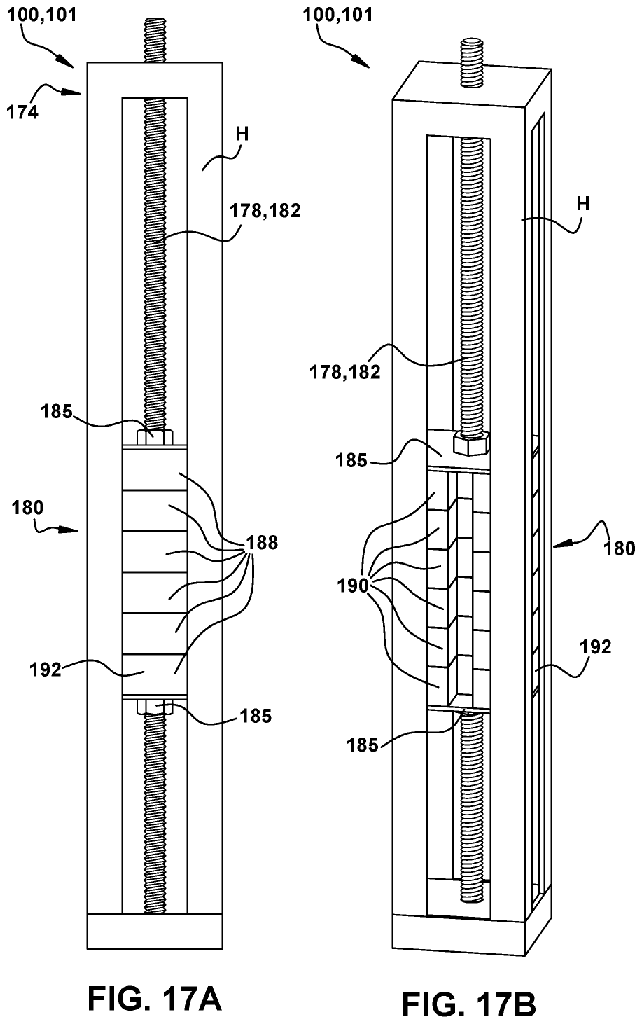

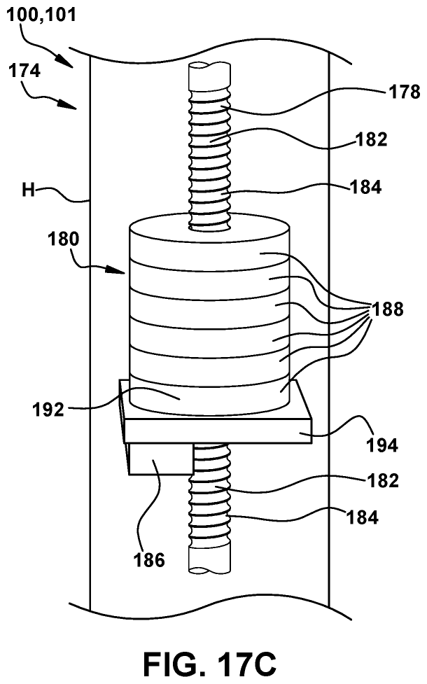

FIG. 9 shows a side view along view line 9-9 in FIG. 1 of an adjustable counterweight system 174. More specifically, FIG. 9, shows an interior view of swing arm 114 along view line 9-9 in FIG. 1. Tilt towers 100, 101 may include an adjustable counterweight system 174 in hollow interior portion 132 of second end 117 of swing arm 114, 114A, and/or 114B. Adjustable counterweight system 174 may provide counterweight balancing of second end 117 of swing arm 114, 114A, 114B to allow for a controlled or slow tilt. As shown in FIGS. 9 and 17A-B, adjustable counterweight system 174 may include a housing H in which subcomponents may be contained. Housing H may be an object for containing subcomponents of adjustable counterweight system 174 and may be sized and shaped to be located within tubes/frames 130 of swing arms 114, 114A, and 114B. Housing H may advantageously be integrated into any imaginable swing arm—new or retrofitted. In embodiments where tilt tower 101 includes swings arms 114A and 114B, as shown in FIGS. 14 and 15, each swing arm 114A and 114B may include respective adjustable counterweight systems 174 in hollow interior portions 132 of second end 117 of swing arms 114A and 114B. Similar to adjustable counterweight system 174, adjustable counterweight systems 174 in swing arms 114A and 114B may provide counterweight balancing of second ends 117 of swing arms 114A and 114B to allow for a controlled or slow rotation. Adjustable counterweight systems 174 may enable a person (not shown) to adjust the mass location of a plurality of weights along a longitudinal axis 176 (FIG. 9) of swing arms 114, 114A, and 114B to compensate for any changes in weight at first end 116 of swing arms 114, 114A, and 114B, e.g., due to new utility equipment, new accessories, environmental aspects like snow or ice, etc. As discussed fully herein, adjustable counterweight systems 174 are more financially economical than removing/adding weights in a fixed manner and requires less time than fixed weights.

FIG. 13 shows a side view along view line 13-13 in FIG. 2 of an adjustable counterweight system (and locking assembly), and FIGS. 17A-C shows an enlarged side or perspective views of adjustable counterweight systems 174, according to other embodiments of the disclosure. Referring to FIGS. 9, 13, and 17A-C, adjustable counterweight systems 174 may each include an elongated member 178 within housing H within hollow interior portion 132 of swing arm 114 at second end 117 of swing arm 114 and configured to receive a plurality of weights 180. An elongated member 178 may be any long member capable of fitting within housing H within hollow interior portion 132 of swing arms 114. Weights are intentionally heavy objects to be mounted within adjustable counterweight system to counterweigh, e.g., first end 116 of swing arm 114, 114A, 114B and utility equipment 102, and are discussed in more detail herein. In certain embodiments, each elongated member 178 may include a threaded rod 182 which is rotatably secured in housing H using now known or later-developed bearings (not shown) that allows rotation thereof. Threaded rod 182 may be a cylindrical rod made of durable materials and including threading 184 (FIG. 17C) (e.g., helical grooves on the surface of threaded rod 182) thereon. Threaded rod 182 may include a threaded nut and keeper plate 185 on either side of plurality of weights 180 to, e.g., selectively secure plurality of weights 180 along a position of elongated member 178.

Each adjustable counterweight system 174 may further include a carrier 194, where carrier 194 is configured to support plurality of weights 180, i.e., a plurality of individual weights 188. Carrier 194 may be any device capable of carrying pluralities of weights 180 relative to elongated member 178. By moving weights 188 along elongated member 178 using carrier 194, the balance and/or speed of rotation of swings arms 114, 114A, and 114B may be altered and/or controlled, e.g., increased or decreased. In embodiments with swing arms 114A and 114B, as shown in FIGS. 14 and 15, adjustable counterweight systems 174 of swing arms 114A and 114B may include carriers 194 which may be substantially similar or even identical to carrier 194 in other implementations.

Each adjustable counterweight system 174 may further include an actuator 186 (FIG. 9), which may be operatively coupled to elongated member 178 and may allow adjustment of a position of plurality of weights 180 along threaded rod 182. Actuator 186 may be any system that allows adjustment of a position of one or more weights 188 in plurality of weights 180 along elongated member 178 by, e.g., moving carrier 194. Moving weights 188 along elongated member 178 moves them relative to swing arm 114, 114A, 114B to adjust the counterbalance of swing arms 114, 114A, and 114B as they rotate. Actuator 186 may take the form of, e.g., a worm drive (not shown), a threaded element, etc., that may turn threaded rod 182 and/or otherwise mover carrier 194 and/or one or more weights 188 relative to threaded rod 182. Similarly, in embodiments with swing arms 114A and 114B, as shown in FIGS. 14 and 15, adjustable counterweight systems 174 of swing arms 114A and 114B may include actuators 186 substantially similar or even identical to actuator 186 in other implementations.

As mentioned previously, each adjustable counterweight system 174 may include respective pluralities of weights 180 therein. Tilt tower 100 may include opening 196 (FIG. 9) at second end 117 of swing arm 114, with opening 196 configured to allow a respective weight 188 of plurality of weights 180 to be added or removed from elongated member 178 of adjustable counterweight system 174. Opening 196 may include an openable or removeable portion 198 (illustrated as dashed line in FIG. 9), which may be, e.g., a door that's closeable to protect the interior of adjustable counterweight system 174. Each weight 188 in pluralities of weights 180 may be immediately adjacent one another. In some implementations, individual weights 188 in each plurality of weights 180 may include a substantially circular exterior profile (FIG. 17C shows an enlarged version of plurality of weights 180). As noted, the number of each individual weights 188 can also be modified, e.g., added or subtracted, to address changes in the center of gravity and/or swing action of swing arms 114, 114A, and 114B. In one embodiment, individual weights 188 may either include internally threaded openings (not shown) therein or carrier 194 may include internally threaded openings (not shown) therein. Weights 188 may be shaped and/or sized to be able to be selectively added or removed, e.g., weights 188 may take the form of U-shaped weights 190 (FIG. 17B), and configured to ride on carrier 194. That is, in some implementations, weights 188 in plurality of weights 180 may be substantially U-shaped and a bottommost weight 192 may contact carrier 194. In any event, the position of weights 188 may be adjusted along a length of elongated members 178 to adjust a center of gravity of swing arms 114, 114A, and 114B. In some embodiments, shown in FIG. 9, each individual weight 188 in plurality of weights 180 may be immediately adjacent one another, e.g., one stacked on top of the other.

Referring to FIGS. 5A, 10A, 10B, and 11A-B, tilt tower 100, 101 may include a rotation limiter 200 for one or more swing arms 114, 114A, and 114B to limit rotation thereof. Rotation limiter 200 may be any mechanical device that selectively limits the rotation of swing arm 114, 114A, 114B. Rotations limiters 200 may be substantially similar or even identical between swing arms 114, 114A, and 114B, except rotation limiter 200 of swing arm 114, 114A, and 114B may have different rotation limits, i.e., swing arms 114, 114A, and 114B may each rotate a different amount of degrees than one another. Rotation limiters 200 prevent first end 116 of swing arms 114, 114A, 114B from possibly hitting lower end 108 of mast 104, a user or other structure near tilt tower 100, 101 on ground G. Rotation limiters 200 may include a first member 202 extending radially from exterior surface 146 of axle 142 (and rotatable therewith), and a second member 204 extending from mast 104 at a position to engage first member 202 at a first predetermined rotational angle α of swing arm 114 relative to mast 104 in a first rotational direction, e.g., clockwise. First members 202 and second members 204 may meet to prevent further rotation, i.e., they meet during rotation of a respective swing arm 114, 114A, and 114B counterclockwise along angle α. Rotation limiters 200 may also each include energy absorber elements 206, e.g., a spring or other elastic member, on at least one of first member 202 and second member 204 to absorb energy when swing arms 114, 114A, and 114B rotate to the predetermined rotational angle α. Energy absorber elements 206 may be replaceable. FIGS. 10A-B show schematic side views of an embodiment in which rotation limiter 200 may also include a third member 210 extending from axle 142 to engage a fourth member 212 extending from mast 104. FIG. 10A shows rotation limiter 200 in a non-rotated position of swing arm 114, and FIG. 10B shows rotation limiters 200 in a schematic manner in which swing arm 114 is rotated in both clockwise and counterclockwise positions (which would not happen at the same time). The position of swing arm 114 is shown by the angled dash line for each rotation. As shown in FIG. 10B, when swing arm 114, 114A, 114B is rotated in a first rotational direction (counterclockwise as shown, along angle α), first members 202 and second members 204 may meet to prevent further rotation, i.e., they meet during rotation of a respective swing arm 114, 114A, and 114B counterclockwise along angle α. As also shown in FIG. 10B, when swing arm 114, 114A, 114B is rotated in a second rotational direction, i.e., clockwise as shown along angle β, third members 210 and fourth members 212 may meet to prevent further rotation, i.e., they meet during rotation of a respective swing arm 114, 114A, and 114B clockwise along angle β. A second energy absorber element 214 may be provided on at least one of third and fourth members 210 and/or 212 to absorb energy when swing arm 114 rotates to the second predetermined rotational angle β. The two sets of members 202, 204 and 210, 212 may be positioned to not interfere with one another, e.g., first and third members 202, 210 may be at different axial locations on axle 142 or second and fourth members 204, 212 may be at different positions along mast 104. Where the desired rotational limits allow, only one set of members 202, 204 or 210, 212 may be used. Also, where the desired rotational limits allow, only one of second and fourth members 204, 212 on mast 104 may be used.

FIG. 12 shows a see-through side view along view line 12-12 in FIG. 1 of a locking assembly 216. Referring to FIGS. 12 and 13, tilt tower 100 may also include a locking assembly 216 coupling second end 117 of swing arm 114 to lower end 108 of mast 104. Locking assembly 216 here is a mechanism for fixing a swing arm 114 so that it may not tilt. In some embodiments, shown in FIGS. 14 and 15, each swing arm 114A and 114B of tilt tower 101 may include a locking assembly 216. Locking assembly 216 may include a first locking member 218 coupled to lower end 108 of mast 104, and a second locking member 220 coupled to second end 117 of a respective swing arm 114, 114A and 114B. Members 218 and 220 can be any structural elements capable of fastening to a respective swing arm 114 or mast 104, e.g., welding, fasteners, etc., and coming into proximity to the other member. Each locking assembly 216 may also include a removable fastener 222 for selectively coupling first locking member 218 to second locking member 220, respectively, to lock a respective swing arm 114, 114A, and 114B relative to mast 104 in an operative position of tilt tower 100 (shown in FIGS. 1, 12-14). Removable fastener 222 can be any fastener capable of coupling first locking member 218 and second locking member 220 such as but not limited to: nut/bolts perhaps with lock washers cotter pins, chain, or pad locks. Removable fastener 222 is removable to allow rotation of a respective swing arms 114 relative to mast 104, see e.g., FIGS. 2 and 15. Locking assemblies 216 may reduce or eliminate moment forces at, e.g., axle 142.

The various embodiments described herein can be used alone on a tilt tower 100 or together in any combination.

Embodiments of the disclosure provide various technical and commercial advantages, examples of which are discussed herein. The tilt tower with a bearing, as described herein, provides a sealed bearing that does not require as frequent lubrication and provides better frictional performance, ensuring reliable and easier operation of the swing arm. The hollow axle allows routing of wiring through the bearing. The tilt tower also reduces stress and fatigue, extending the lifespan of the tower, and allows for scaling for larger and taller applications, such as cell towers. The provision of two swing arms allows for addition of utility equipment beyond what is currently available. The adjustable counterweight system allows adjustment of the counterweights to maintain safe use of the tower by ensuring rotational balance.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise. “Approximately” or “about,” as applied to a particular value of a range, applies to both end values and, unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application and to enable others of ordinary skill in the art to understand the disclosure for various embodiments with various modifications as are suited to the particular use contemplated.

What is claimed is:

1. A tilt tower, comprising:
a mast fixed to ground;
a swing arm including a tube with a hollow interior portion; and
a bearing rotatably coupling the swing arm to a side of an upper end of the mast, the bearing including:
a bearing seat coupled to the side of the upper end of the mast,
an axle coupled to an exterior surface of the respective swing arm, wherein the axle includes a hollow interior portion connected to the interior of the tube of the swing arm, and
a sealed roller bearing between the axle and the mast.

2. The tilt tower of claim 1, wherein the hollow interior of the axle is open to the hollow interior portion of the tube of the swing arm through an opening in a side of the swing arm.

3. The tilt tower of claim 1, wherein the axle is cylindrical and includes a uniform circumference throughout the length of the axle.

4. The tilt tower of claim 1, wherein the sealed roller bearing is at least partially within a bearing seat of the bearing.

5. The tilt tower of claim 1, wherein the axle includes a flange extending radially from a surface of the axle and is connected to the mast, and the bearing seat is at least partially about the flange.

6. The tilt tower of claim 5, wherein the flange is operatively coupled to a backing plate between the flange and the mast.

7. The tilt tower of claim 1, wherein the bearing seat of the bearing includes a first portion including a first hemispherical bearing surface and a second portion including a second hemispherical bearing surface, wherein the first portion and the second portion collectively form a respective circular bearing surface about the axle.

8. A tilt tower, comprising:
a mast fixed to ground;
a swing arm; and
a bearing rotatably coupling the swing arm to a side of an upper end of the mast, the bearing including:
a bearing seat coupled to the side of the upper end of the mast, the bearing seat including first portion including a first hemispherical bearing surface and a second portion including a second hemispherical bearing surface, wherein the first portion and the second portion collectively form a circular bearing surface,
an axle coupled to an exterior surface of the swing arm, and
a sealed roller bearing between the axle and the mast.

9. The tilt tower of claim 8, wherein the bearing seat is physically connected to the side of the upper end of the mast by at least two fasteners, and wherein the bearing seat is selectively removable from the side of the upper end of the mast.

10. The tilt tower of claim 8, wherein first hemispherical bearing surface and second hemispherical bearing surface collectively form the circular bearing surface about the sealed roller bearing.

11. The tilt tower of claim 8, wherein the sealed roller bearing is a spherical sealed roller bearing.

12. The tilt tower of claim 8, wherein the sealed roller bearing is at least partially within a bearing seat of the bearing.

13. The tilt tower of claim 8, wherein the first portion of the bearing seat is permanently fixed to the mast.

14. The tilt tower of claim 8, wherein the second portion of the bearing seat is selectively removable from the mast.

15. The tilt tower of claim 8, wherein the axle includes a flange extending radially from a surface of the axle and is connected to the mast, the first portion and the portion each between the axle and the mast.

16. A tilt tower, comprising:
a mast fixed to ground;
a swing arm; and
a bearing rotatably coupling the swing arm to a side of an upper end of the mast, the bearing including:
a bearing seat coupled to the side of the upper end of the mast, the bearing seat including a first portion including a first hemispherical bearing surface and a second portion including a second hemispherical bearing surface,
an axle coupled to an exterior surface of the first swing arm, wherein the axle includes a hollow interior portion connected to the interior of the first swing arm, and
a sealed roller bearing between the axle and the mast.

17. The tilt tower of claim 16, wherein the bearing seat is physically connected to the mast by at least two fasteners and is selectively removable from the side of the mast.

18. The tilt tower of claim 16, wherein the first portion and the second portion collectively form a circular bearing surface.

19. The tilt tower of claim 16, where the first hemispherical bearing surface includes a first arced surface including a first length different from a second length of a second arced surface of the second hemispherical bearing surface.

20. The tilt tower of claim 16, wherein the first portion of the bearing seat is permanently fixed to the side of the upper end of the mast and the second portion of the first bearing seat is selectively removable from the side of the upper end of the mast.
